(19) United States
(12) Patent Application Publication
(10) Pub. No.: US 2012/0072841 A1
(43) Pub. Date: Mar. 22, 2012

(54) Browser-Based Song Creation

(75) Inventor: David Moricca, Brooklyn, NY (US)

(73) Assignee: ROCKSTAR MUSIC, INC., Brooklyn, NY (US)

(21) Appl. No.: 13/208,442

(22) Filed: Aug. 12, 2011

Related U.S. Application Data
(60) Provisional application No. 61/373,677, filed on Aug. 13, 2010.

(51) Int. Cl. G06F 3/01

(52) U.S. Cl. 715/716

(57) ABSTRACT

A client presents a set of user interfaces within a web browser application operating on the client. The user interfaces enable a user of the client to create and distribute songs. When the user is creating a song, the client generates instrumental data and/or vocals data in response to input received from the user via the user interfaces. The instrumental data represents an instrumental part of a song. The vocals data represents a vocals part of the song. The vocals data is generated using a microphone controlled by the user via the user interfaces. The client generates an audio file using the instrumental data and the vocals data. The audio file comprises a digital audio recording of the song.

### BACKGROUND

People enjoy expressing themselves through music. However, it may be difficult for people to create their own music because they do not enjoy access to all of equipment needed to make music. Moreover, even if people had access to the necessary equipment, many people do not have the training or skills to use the equipment. Furthermore, even if such people were able to create their own music, such people would also need to exert a great deal of effort to get other people to hear their music.

### SUMMARY

A client presents a set of user interfaces within a web browser application operating on the client. The user interfaces enable a user of the client to create and distribute songs. When the user is creating a song, the client generates instrumental data and/or vocals data in response to input received from the user via the user interfaces. The instrumental data represents an instrumental part of a song. The vocals data represents a vocals part of the song. The vocals data is generated using a microphone controlled by the user via one or more of the user interfaces. The client generates an audio file using the instrumental data and/or the vocals data. The audio file comprises a digital audio recording of the song.

This summary is provided to introduce a selection of concepts. These concepts are further described below in the Detailed Description. This summary is not intended to identify key features or essential features of the claimed subject matter, nor is this summary intended as an aid in determining the scope of the claimed subject matter.

### BRIEF DESCRIPTION OF THE DRAWINGS

FIG. 1 is a block diagram illustrating an example system.

FIG. 2 is a block diagram illustrating example details of a client.

FIG. 3 is a block diagram illustrating example details of an interactivity component in the client.

FIG. 4 is a flowchart illustrating an example operation performed by a user to compose a song.

FIG. 5 is a screen illustration that illustrates an example beatmaker interface.

FIG. 6 is a screen illustration that illustrates an example vocals interface.

FIG. 7 is a flowchart illustrating an example operation performed by a producer to generate a song kit.

FIG. 8 is a screen illustration that illustrates an example producer interface.

FIG. 9 is a block diagram illustrating an example computing device.

### DETAILED DESCRIPTION

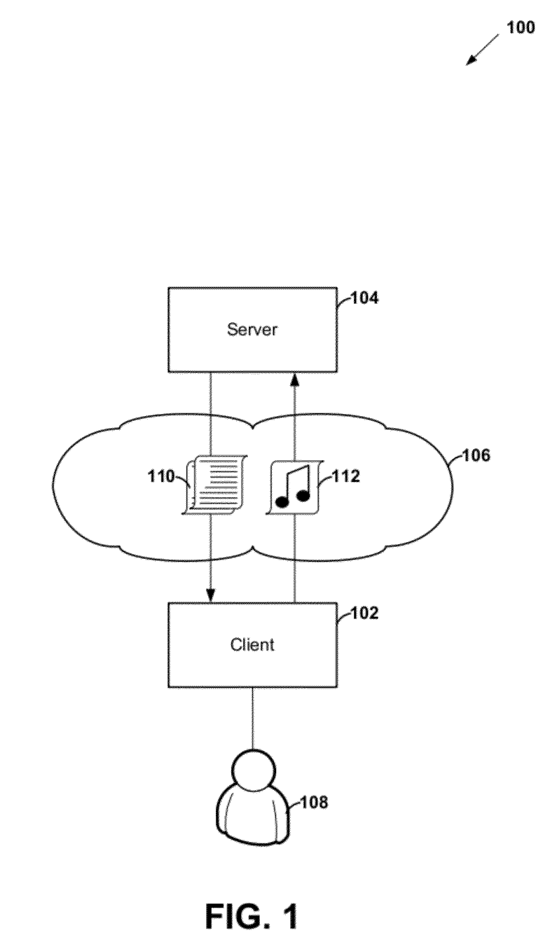

FIG. 1 is a block diagram illustrating an example system 100. As illustrated in the example of FIG. 1, the system 100 comprises a client 102, a server 104, and a network 106. A user 108 uses the client 102. It should be appreciated that the system 100 is only one example embodiment. There can be many other embodiments. For example, in other embodiments, there can be multiple clients, servers, networks, and users.

The client 102 and the server 104 each comprises one or more computing devices. Computing devices include physical devices that process information. The user 108 is a person who uses the client 102. The network 106 is a communications network that facilitates communication between the client 102 and the server 104. In various embodiments, the network 106 can be various types of communications network. For example, the network 106 can be a wide area network, such as the Internet, a local area network, such as a corporate network, or another type of communications network.

A web browser application operates on the client 102. The web browser application is a software application for retrieving and presenting information resources on the World Wide Web. The server 104 provides a song creation service. The song creation service is a service that enables users to create and distribute songs. To use the song creation service, the user 108 uses the web browser application to retrieve interface data 110 from the server 104. The client 102 sends one or more requests to the server 104 to retrieve the interface data 110 from the server 110. The client 102 processes the interface data to present one or more user interfaces within one or more browser windows. The browser windows are windows associated with the web browser application.

The client 102 generates instrumental data in response to input received from the user 108 via the user interfaces. The instrumental data represents an instrumental part of a song. For example, the instrumental data can represent drum, bass guitar, synthesizer, and lead guitar parts of the song. In addition, the client 102 generates vocals data in response to input received from the user 108 via the user interfaces. The vocals data represents a vocals part of the song. For example, the vocals data can comprise one or more vocals tracks sung by the user 108 or another person. The client 102 uses a signal from a microphone to generate the vocals data. The microphone is controlled by the user 108 via the one or more user interfaces.

The client 102 uses the instrumental data and the vocals data to generate an audio file 112. The audio file 112 comprises a digital audio recording of the song. In various embodiments, the audio file 112 can have various formats. For example, the audio file 112 can be an MP3 file, an Ogg Vorbis file, a Windows Media Audio (WMA) file, an Advanced Audio Coding (AAC) file, a WAV file, or another format for digitally encoding sound. In response to input received from the user 108 via the user interfaces, the client 102 uploads the audio file 112 to the server 104.

In addition to the song creation service, the server 104 provides song distribution services. The song distribution services help users to publicize and distribute songs uploaded to the server 104. For example, the song distribution services can post songs to social networking sites, such as Facebook, MySpace, YouTube, Orkut, and so on. In another example, the song distribution services can generate charts that rank uploaded songs by absolute popularity, by relative rise in popularity, by most listened, by most downloads, by time created, or by other criteria. The song distribution services also enable users to download or stream audio files uploaded to the server 104. In this way, the distribution services of the server 104 help publicize and distribute songs generated by users using the song creation service of the server 104.

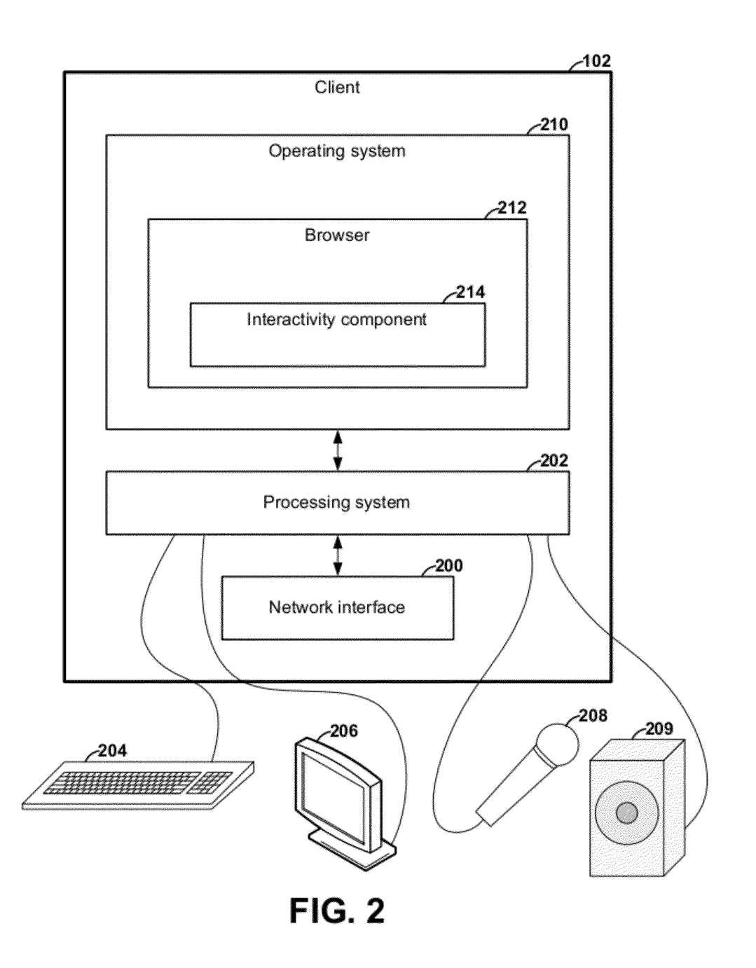

FIG. 2 is a block diagram illustrating example details of the client 102. As mentioned elsewhere in this document, the client 102 comprises one or more computing devices. In various embodiments, the client 102 can comprise various types of computing devices. For example, the client 102 can comprise a laptop computer, a desktop computer, a netbook computer, a smartphone (e.g., an Apple iPhone), a tablet computer, a personal media player (e.g., an Apple iPod Touch), a network-enabled television, a television set top box, a video game console, a handheld video game device, an in-vehicle computing device, a mainframe computer, or another type of computing device.

As illustrated in the example of FIG. 2, the client 102 comprises a network interface 200, and a processing system 202. The network interface 200 enables the client 102 to send to and receive data from the network 106. The processing system 202 comprises one or more processing units that are capable of executing computer-executable instructions. The client 102 also has a QWERTY keyboard 204, a display unit 206, a microphone 208, and a speaker 209. Although the QWERTY keyboard 204, the display unit 206, the microphone 208, and the speaker 209 are illustrated as being outside the client 102, the QWERTY keyboard 204, the display unit 206, the microphone 208, and the speaker 209 can be integrated into the client 102. Furthermore, the QWERTY keyboard 204, the display unit 206, the microphone 208, and the speaker 209 can have different forms than those illustrated in the example of FIG. 2.

The processing system 202 executes computer-executable media that cause the client 102 to run an operating system 210, a browser 212, and an interactivity component 214. These computer-executable instructions can be stored on one or more computer storage media, such as hard disk drives, random access memory (RAM) modules, optical discs, and/or other types of computer storage media. In various embodiments, the operating system 210 can be an instance of various types of operating systems. For example, the operating system 210 can be an instance of a Microsoft Windows 7 operating system, an instance of a Microsoft Windows Mobile operating system, an instance of an Apple OS X operating system, an instance of an Apple iOS operating system, an instance of a RIM BlackBerry OS operating system, an instance of a Google Chromium operating system, an instance of a Google Android operating system, an instance of a Linux operating system, an instance of a Symbian OS operating system, or an instance of another type of operating system.

The browser 212 is a web browser application that runs on the operating system 210. For instance, the operating system 210 manages how the browser 212 uses hardware resources of the client 102. In various embodiments, the browser 212 can be various types of web browser applications. For example, the browser 212 can be an instance of a Microsoft Internet Explorer web browser application, an instance of a Mozilla Firefox web browser application, an instance of a Google Chrome web browser application, an instance of an Apple Safari web browser application, an instance of a RIM BlackBerry web browser application, an instance of an Opera web browser application by Opera Software ASA, or an instance of another type of web browser application.

The network interface 200 receives the interface data 110 from the server 104 via the network 106. When the network interface 200 receives the interface data 110, the browser 212 uses the operating system 210 receive the interface data 110. The browser 212 then passes the interface data 110 to the interactivity component 214. The interactivity component 214 is a software component of the browser 212 that generates interactive user interfaces within windows associated with the browser 212. In various embodiments the interactivity component 214 can be various types of software components. For example, the interactivity component 214 can be a Flash plug-in from Abode Systems Inc., a Silverlight plug-in from Microsoft Corporation, a Moonlight plug-in from Novell, Inc., a component that processes HTML5, a Java virtual machine, or another type of software component that generates interactive user interfaces within windows associated with the browser 212.

The interface data 110 causes the interactivity component 214 to display one or more user interfaces in one or more browser windows on the display unit 206. Furthermore, the interface data 110 causes the interactivity component 214 to generate instrumental data and vocals data in response to input received by the client 102 via the user interfaces. The instrumental data represents an instrumental part of a song. The vocals data represents a vocals part of the song. The user 108 uses the QWERTY keyboard 204, the microphone 208, and/or other input devices to provide the input to the client 102 via the user interfaces.

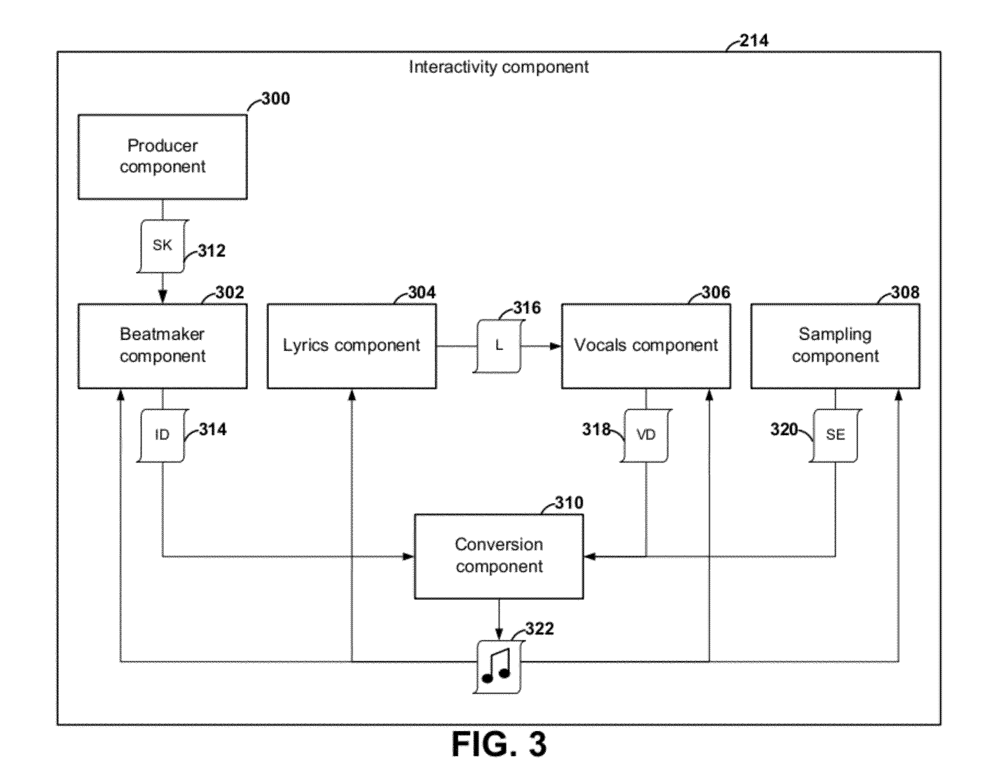

FIG. 3 is a block diagram illustrating example details of the interactivity component 214. As illustrated in the example of FIG. 3, the interactivity component 214 comprises a producer component 300, a beatmaker component 302, a lyrics component 304, a vocals component 306, a sampling component 308, and a conversion component 310. The producer component 300, the beatmaker component 302, the lyrics component 304, the vocals component 306, the sampling component 308, and the conversion component 310 represent functionality provided by the interactivity component 214 when the interactivity component 214 processes interface data from the server 104.

The producer component 300 receives producer interface data from the server 104. The producer interface data causes the display unit 206 to display a producer interface. The producer interface is a set of one or more user interfaces that enable a user to create a song kit 312. To avoid confusion with the user 108, a user who is producing a song kit (sometimes referred to as a beat kit) is referred to herein as a producer. The client used by the producer can be referred herein as the producer client and the client used by the user 108 can be referred to herein as the composer client. It should be appreciated that the user 108 can be a producer as well as someone who composes songs.

The song kit 312 comprises a set of one or more pre-defined beats. In some embodiments, each of the beats is a Musical Instrument Digital Interface (MIDI) sequence. In other embodiments, each of the beats is a recorded sample. Typically, a beat is relatively short. For example, the producer component 300 can impose a limit of eight bars on the beats. Each of the beats is associated with a musical instrument. For example, a beat can be associated with a bass guitar and another beat can be associated with a snare drum. Multiple beats in the song kit can be associated with a single instrument. For example, the song kit 312 can include eight beats associated with a bass guitar.

The beatmaker component 302 causes the display unit 206 to display a beatmaker interface. The beatmaker interface is a set of one or more user interfaces that enable the user 108 to create an instrumental part for a song. Particularly, the beatmaker interface enables the user 108 to use the beats in the song kit 312 to create the instrumental part of a song. Although the example of FIG. 3 shows the song kit 312 as being passed directly from the producer component 300 to the beatmaker component 302, it should be appreciated that in some embodiments, the song kit 312 is uploaded to the server 104 and then separately downloaded to the client 102. Furthermore, it should be appreciated that the song kit 312 may be created and used on different client. In other words, a user of one client can create the song kit 312 and a user of another client can create an instrumental part of a song using the song kit 312.

In addition to providing beats, the producer component 300 can also provide a vocals kit interface. In the vocal kits interface, the producer uploads multiple (e.g., 3) versions of the song for karaoke purposes: an instrumental version, an a cappella vocal version and a fully mixed down song. These three versions are all in a specific format, such as Mp3 format. Additionally, the producer writes lyrics using the lyrics tool. And each lyric is set to the right beat and measure (linear position) in the song.

The producer component can also be used to provide remix kits, which is creating a beat kit out of audio stems from known songs. The producer can provide a similar number of versions for the remix kits in the vocal kits interface. In yet another example, the producer component 300 allows the producer to provide pro vocal kits, which is creating a karaoke type kit for known songs. Other configurations are possible.

As described in detail elsewhere in this document, the user 108 creates an instrumental part for a song by creating parts for musical instruments in the song kit 312. The user 108 creates a part for a musical instrument by selecting start and stop times for beats associated with the musical instrument. Between a start time and a stop time for a beat, the beat loops. In other words, the beat starts playing at the start time and continues repeating itself until the stop time. The beatmaker interface includes one or more beat controls that allow the user 108 to start and stop looping of beats.

As the user 108 selects start and stop times for beats associated with instruments in the song kit 312, the beatmaker component 302 generates instrumental data 314. The instrumental data 314 represents the instrumental part of the song. In various embodiments, the instrumental data 314 represents the instrumental part of the song in various ways. For example, the instrumental data 314 can be an extensible markup language (XML) file. The XML file contains channel elements for each musical instrument used in the song. The channel elements include elements that specify a sequence of note elements. Each note element specifies a note to be played, a duration of the note, a start time of the note, and a velocity of the note. Furthermore, the channel elements can include elements that specify effects applied to the notes. An example XML file is attached to this document as APPENDIX A.

The conversion component 310 receives the instrumental data 314 from the beatmaker component 302. The conversion component 310 uses the instrumental data 314 and any data representing other parts of the song to generate an audio file 322. The audio file 322 comprises audio data representing the sound wave of the song. In various embodiments, the audio file 322 can be in various formats. For example, the audio file 322 can be in the MP3 format, the Ogg Vorbis format, the WAV format, or another format.

The lyrics component 304 is an optional component for the system. For example, in some embodiments, the lyrics are provided as part of the kit by the producer.

For example, to provide lyrics, the producer can be presented with a visual linear display of the song. The producer breaks the song into song sections by clicking and dragging on the timeline. Each section will be snapped to the nearest measure. Once the song is divided, the producer is presented with a zoomed in view of the song (now broken into sections). The producer then draws lyric regions within each song section. Each lyric region will be snapped to the nearest beat. The producer also inputs the lyrics for each lyric region by typing text into the corresponding field. After the lyrics are set, the producer can create a sample vocal track for the karaoke experience.

However, in other examples, the user can use the lyrics component 304 to receive the audio file 322 from the conversion component 310. The lyrics component 304 causes the display unit 206 to display a lyrics interface. The lyrics interface is a set of one or more user interfaces that help the user 108 to create lyrics for the song. The lyrics component 304 uses the audio file 322 to cause the speaker 209 to play back the existing parts of the song while the user 108 is composing lyrics for the song. For example, if the user 108 has only composed the instrumental parts of the song so far, the audio file 322 comprises audio data that represents the instrumental part of the song. In this example, the user 108 hears the instrumental part of the song when the lyrics component 304 plays back the audio file 322. In another example, if the user 108 has composed the instrumental parts of the song, a background vocal part for the song, and a samples part for the song, the audio file 322 comprises audio data representing the sound wave of the instrumental parts of the song, the background vocal part of the song, and the samples added to the song. Hearing the existing parts of the song can help the user 108 compose lyrics for the song. The lyrics component 304 generates lyrics data 316. The lyrics data 316 represents the lyrics for the song.

The vocals component 306 causes the display unit 206 to display a vocals interface. The vocals interface is a set of one or more user interfaces that enable the user 108 to create a vocals part for the song. Particularly, the vocals interface enables the user 108 to record one or more vocals tracks for the song. In this way, the user 108 can layer multiple vocal parts into the song. The vocals interface includes controls that allow the user 108 to start and stop recording signals from the microphone 208. In embodiments where the interactivity component 214 is an Adobe Flash player, the vocals component 306 can use the GetMicrophone command to get the signal from the microphone 208.

The vocals component 306 can receive the audio file 322. The vocals component 306 uses the audio file 322 to play back the existing parts of the song while the user 108 is recording vocal parts of the song. In this way, the user 108 can attempt to synchronize the vocal parts of the song with the existing parts of the song. Furthermore, the vocals component 306 can receive the lyrics data 316 from the lyrics component 304. The vocals component 306 can display the lyrics of the song as the user 108 is recording vocal tracks of the song. In this way, the user 108 can read the lyrics of the song in the vocals interface as the user 108 is singing the lyrics.

The vocals component 306 generates vocals data 318. The vocals data 318 represents the vocals part of the song. In various embodiments, the vocals data 318 can be represented in various formats. For example, the vocals data 318 can be formatted in the WAV format. In some embodiments, the vocals component 306 can generate separate sets of vocals data for different vocal tracks of the song.

The vocals component 306 can include additional functionality as well. For example, the vocals component 306 can provide the user with the ability to review and edit lyrics, including lyrics provided as part of a vocal kit. In addition, the vocals component 306 can provide a pitch fix feature that allows the user to tune his or her voice as part of preparing and recording the vocals. Such a pitch fix can be provided in multiple flavors, such as a clean pitch fix and a robotic pitch fix that provides more distortion for the vocals. Finally, the vocals component 306 can be modified to accept additional forms of input beyond vocal, such as other instrumental input like guitar, flute, etc.

The conversion component 310 receives the vocals data 318 from the vocals component 306. The conversion component 310 uses the vocals data 318 and any data representing other existing parts of the song to regenerate the audio file 322. For example, if the beatmaker component 302 has already generated the instrumental data 314, the conversion component 310 uses the instrumental data 314 and the vocals data 318 to regenerate the audio file 322. The regenerated version of the audio file 322 contains audio data representing a combined sound wave of the existing parts of the song.

The sampling component 308 causes the display unit 206 to display a sampling interface. The sampling interface enables the user 108 to add sound samples to the song. For example, the sampling interface can enable the user 108 to add explosion sounds, whistle sounds, gunshot sounds, whip sounds, siren sounds, vocal samples, drum sounds, and other types of audio samples to the song. The sampling component 308 uses the audio file 322 to play back existing parts of the song so that the user 108 can insert the desired sound samples that the appropriate places in the song.

The sampling component 308 outputs sampling data 320. The sampling data 320 represents the sound samples added to the song. In various embodiments, the sampling data 320 can have various formats. For example, the sampling data 320 can be formatted as an XML file containing elements the specify times in the song when various sound samples occur, volumes of the sound samples, and other information about the sound samples. In another example, the sampling data 320 can be a WAV file containing audio data representing the sound samples added to the song. The conversion component 310 receives the sampling data 320 from the sampling component 308. The conversion component 310 uses the sampling data 320 along with the instrumental data 314 and the vocals data 318 (if they exist) to regenerate the audio file 322. The regenerated audio file 322 contains audio data representing a combined sound wave for the existing parts of the song.

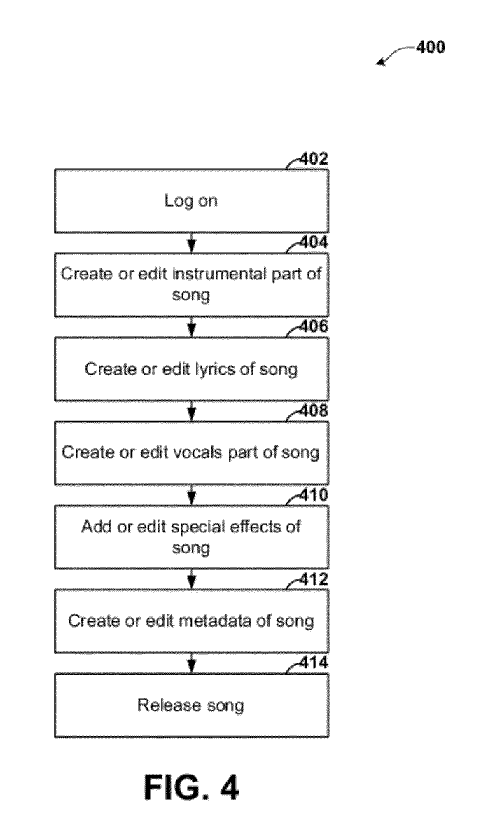

FIG. 4 is a flowchart illustrating an example operation 400 performed by the user 108 to compose a song. As illustrated in the example of FIG. 4, the operation 400 begins when the user 108 logs on to the song creation service provided by the server 104 (402). The user 108 uses the browser 212 to log on to the song creation service.

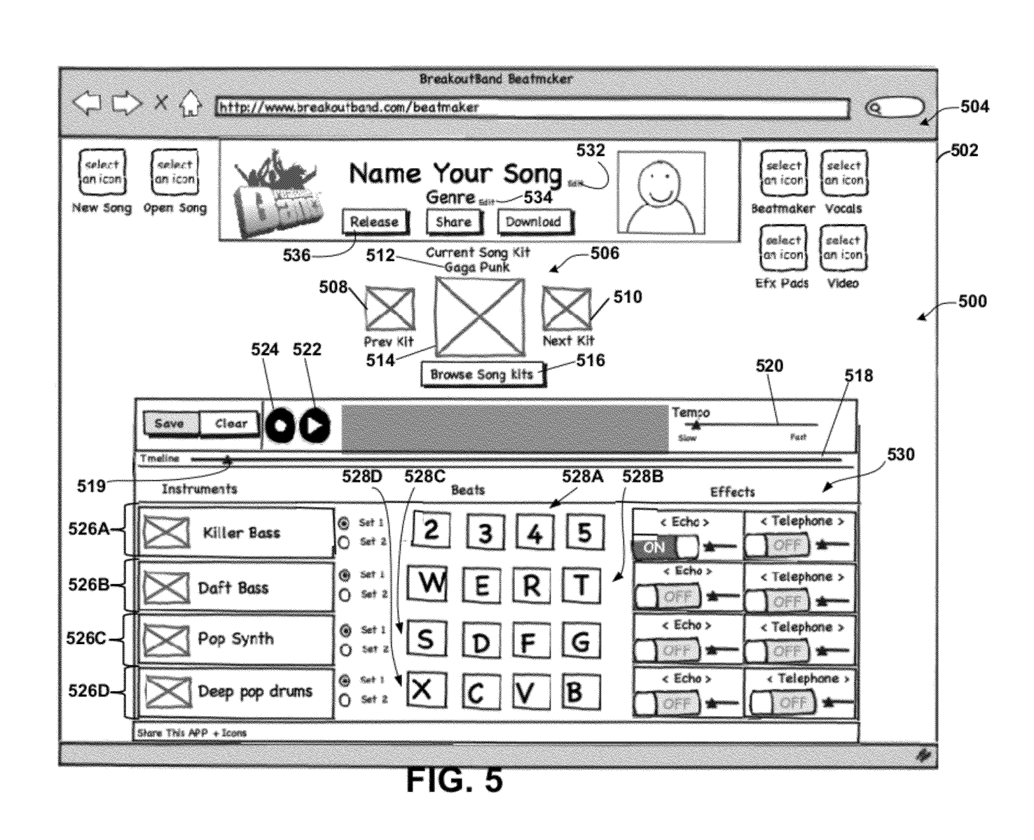

After logging on to the song creation service, the user 108 can create or edit an instrumental part of a song (404). The user 108 uses a beatmaker interface to create or edit the instrumental part of the song. In various embodiments, the beatmaker interface can have various appearances and styles. FIG. 5 is a screen illustration that illustrates an example beatmaker interface 500. It should be appreciated that the beatmaker interface can have different formats, styles, controls, elements, and functionality other than the beatmaker interface 500.

As illustrated in the example of FIG. 5, the beatmaker interface 500 is within a browser window 502. The browser window 502 is a window associated with the browser 212. In addition to the beatmaker interface 500, the browser window 502 also includes web navigation controls 504. In the example of FIG. 5, the web navigation controls 504 include a back button, a forward button, a stop button, a home button, a navigation bar, and a search text entry box.

The beatmaker interface 500 comprises song kit selection controls 506. The song kit selection controls 506 enable the user 108 to select a song kit from among a plurality of available song kits. The song kit selection controls 506 include a previous kit button 508 and a next kit button 510. By selecting the previous kit button 508 and the next kit button 510, the user 108 can sequentially review the available song kits. The beatmaker interface 500 includes a kit title 512 and a kit picture 514. The kit title 512 specifies a name of the currently selected song kit. The kit picture 514 is an image associated with the currently selected song kit. Different ones of the available song kits have different names and are associated with different images. Other information, such as genre, influences, and user ratings can be associated with each kit in the beatmaker interface 500.

The song kit selection controls 506 also include a browse song kits button 516. In some embodiments, the user 108 may be required to pay a fee to use certain song kits. When the browse song kit button 516 is selected, the beatmaker interface 500 displays a gallery of available song kits. The different available song kits can be associated with different instruments and beats.

The beatmaker interface 500 also comprises a timeline 518. The timeline 518 includes an indicator 519 that indicates a current time and measure in a song. The user 108 can move the indicator 519 along the timeline 518. Positions along the timeline 518 correspond to times and measures in the song. Thus, by moving the indicator 519 along the timeline 518, the user 108 can skip to different times and measures in the song. Furthermore, the beatmaker interface 500 comprises a tempo control 520. The tempo control 520 enables the user 108 to set the tempo for the song. In some embodiments, the selected song kit specifies a default tempo for the song.

The beatmaker interface 500 also comprises a record button 522 and a stop button 524. When the user 108 selects the record button 522, the indicator 519 progresses from left to right along the timeline 518. The indicator 519 continues to progress along the timeline 518 until either the user 108 selects the stop button 524 or the indicator 519 reaches a point corresponding to a maximum permitted song length.

Furthermore, the beatmaker interface 500 comprises instrument control groups 526A through 526D (collectively, “instrument control groups 526”). Each of the instrument control groups 526 corresponds to an instrument in the selected song kit. When the user 108 selects different song kits, the instrument control groups 526 can correspond to different instruments. In the example of FIG. 5, the currently selected song kit is titled “Gaga Punk” and the instrument control groups 526 correspond to a “killer bass” instrument, a “daft bass” instrument, a “pop synth” instrument, and a “deep pop drums” instrument. If the user 108 selects another song kit titled “Allegheny Country,” the instrument control groups 526 could correspond to a “banjo” instrument, a “steel guitar” instrument, an “acoustic guitar” instrument, and a “harmonica” instrument.

In some embodiments, the user 108 is able to choose which instruments in the selected song kit correspond to the instrument control groups 526. For example, the selected song kit could include eight musical instruments. In this example, the user 108 can choose four of the eight musical instruments to correspond to the instrument control groups 526. Furthermore, in some embodiments, the user 108 can choose a single instrument to correspond to two or more of the instrument control groups 526. For example, the user 108 can choose the “daft bass” instrument to correspond to the instrument control group 526B and the instrument control group 526C. This would be analogous to having two people in a band playing bass guitars.

The instrument control groups 526A through 526D include beat controls 528A through 528D (collectively, “beat controls 528”). The beat controls 528 in an instrument control group correspond to different beats for the instrument associated with the instrument control group. In the example of FIG. 5, the beat controls 528A correspond to different beats for the “killer bass” instrument, the beat controls 528B correspond to different beats for the “daft bass” instrument, and so on.

As discussed above, the indicator 519 progresses along the timeline 518 when the user 108 has selected the record button 522. As the indicator 519 is progressing along the timeline 518, the user 108 can select the beat controls 528. When the user 108 selects the beat controls 528, the beat controls enter a selected state. When a given one of the beat controls 528 enters the selected state, the beat corresponding to the given beat control starts playing. Thus, by selecting a given one of the beat controls 528 when the indicator 519 is at a given position on the timeline 518, the user 108 indicates that the corresponding beat is to start playing at a time in the song corresponding to the given position. For example, if the user 108 selects the given beat control when the indicator 519 is at a position corresponding to sixty seconds into the song, the corresponding beat starts playing at sixty seconds into the song.

When the user 108 selects ones of the beat controls 528 that are already in the selected state, the selected beat controls exit the selected state. When a given one of the beat controls 528 exits the selected state, the beat corresponding to the given beat control stops playing. Thus, by selecting the given beat control when the indicator 519 is at a given position on the timeline 518, the user 108 indicates that the corresponding beat is to stop playing at a time in the song corresponding to the given position on the timeline 518. For example, if the user 108 selects the given beat control again when the indicator 519 is at a position corresponding to ninety seconds into the song, the corresponding beat stops playing at ninety seconds into the song.

The beat controls 528 in different ones of the instrument control groups 526 can concurrently be in the selected state. For example, one of the beat controls 528A, one of the beat controls 528B, and one of the beat controls 528D can concurrently be in the selected state. When multiple ones of the beat controls 528 are concurrently in the selected state, the corresponding beats play back concurrently. In this way, the user 108 can layer the parts of different instruments to form the instrumental part of the song.

However, in some embodiments, the beatmaker interface 500 does not permit two of the beat controls in the same one of the instrument control groups 526 to be in the selected state at the same time. This is because the instrument control groups 526 correspond to individual musical instruments. In real life, an individual musical instrument cannot play two or more beats simultaneously. In such embodiments, the user 108 can select a first one of the beat controls for a musical instrument while a second one of the beat controls for the musical instrument is in the selected state. In this situation, the second beat control automatically exits the selected state and the first beat control enters the selected state. In this way, the user 108 can cause the part for the musical instrument to transition from one beat to another beat seamlessly with just one input. If two or more of the instrument controls groups 526 correspond to the same musical instrument, beat controls in these instrument control groups can be in the selected state at the same time. This is analogous to having two or more of the same type of instrument in a band playing the same or different beats.

The user 108 can select the beat controls 528 in multiple ways. For example, the user 108 can select individual ones of the beat controls 528 by clicking on the beat controls 528 using a pointer, such as a mouse or trackball. Furthermore, each of the beat controls 528 is assigned to a key on the QWERTY keyboard 204. As illustrated in the example of FIG. 5, the beat controls 528A are assigned to the keys “2,” “3,” “4,” and “5.” Furthermore, the beat controls 528B are assigned to the keys “W,” “E,” “R,” and “T.” If a given one of the beat controls 528 is not in the selected state, pressing a key on the QWERTY keyboard 204 assigned to the given beat control causes the given beat control to enter the selected state. For example, if the user 108 presses the “W” button on the QWERTY keyboard 204 when the beat control assigned to the “W” button is not in the selected state, the beat control assigned to the “W” button enters the selected state. If a given one of the beat controls 528 is already in the selected state, pressing a key on the QWERTY keyboard 204 assigned to the given beat control causes the given beat control to exit the selected state.

The instrument control groups 526 also include effects controls 530. The effects controls 530 enable the user 108 to apply various effects to the parts for the musical instruments associated with the instrument control groups. The effects alter the sound of the beats. Example effects include echo, telephone, robot, filter, reverb, delay, distortion, modulation, degrader, scream, phaser, bit grunge, flanging effects, and so on. For example, the user 108 can use one of the effects controls 530 to apply an echo effect to the beats for the “killer bass” instrument. The user 108 can choose the effect by selecting controls on either side of the title of the effect in the effects controls 530. In some embodiments, the user 108 may be required to pay a fee to apply particular effects. Furthermore, the effects controls 530 include intensity controls that allow the user 108 to control the intensities of the effects.

In example embodiments, the user 108 can arm one or multiple tracks in the beatmaker interface 500. This allows the user 108 to record track by track or all tracks at one time. Each track can be shown with a separate timeline and can be controlled separately. For example, each track can be separately controlled for characteristics like volume.

Reference is now made again to the example of FIG. 4. After the user 108 creates or edits the song using the beatmaker interface, the user 108 creates or edits lyrics for the song (406). The user 108 uses the lyrics interface to create or edit the lyrics for the song. In various embodiments, the lyrics interface can have various appearances, styles, and functionality.

In some embodiments, the lyrics interface includes one or more structure selection controls. The structure selection controls enable the user 108 to specify a lyrical structure for the song. For example, the user 108 can use the structure selection controls to specify a lyrical structure comprising an intro, a first verse, a chorus, a second verse, a chorus, a third verse, a chorus, a chorus, and an outro. In another example, the user 108 can use the structure selection controls to specify a lyrical structure comprising a first verse, a chorus, a second verse, a chorus, and an outro. Furthermore, the lyrics interface includes lyric entry controls that enable the user 108 to enter lyrics for the intro, verses, chorus, and outro in the selected lyrical structure.

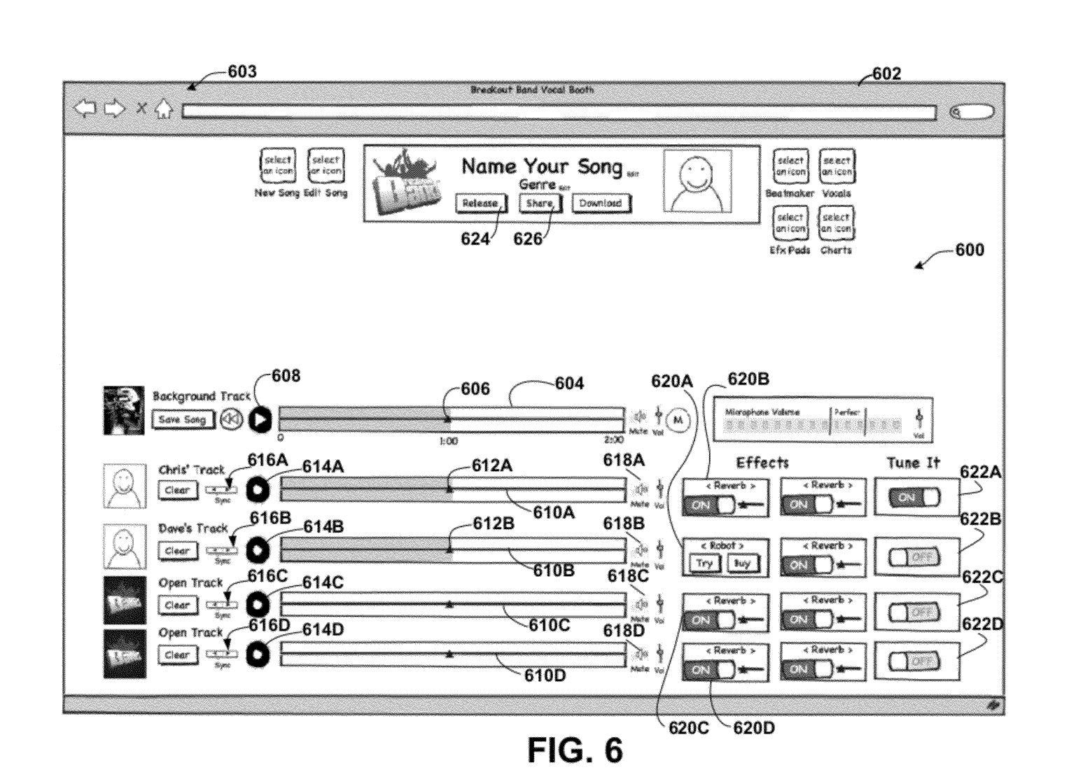

After the user 108 creates the lyrics for the song, the user 108 creates or edits the vocals part of the song (408). The user 108 uses the vocals interface to create or edit the vocal part of the vocals part of the song. In various embodiments, the vocals interface can have various appearances and styles. FIG. 6 is a screen illustration that illustrates an example vocals interface 600. It should be appreciated that the vocals interface can have different formats, styles, controls, elements, and functionality than the vocals interface 600.

As illustrated in the example of FIG. 6, the vocals interface 600 is within a browser window 602. The browser window 602 is a window associated with the browser 212. In addition to the vocals interface 600, the browser window 602 also includes web navigation controls 603. In the example of FIG. 6, the web navigation controls 603 include a back button, a forward button, a stop button, a home button, a navigation bar, and a search text entry box.

The vocals interface 600 comprises an overall timeline 604. Different positions along the overall timeline 604 correspond to different times in the song. Positions toward the left end of the overall timeline 604 correspond to times early in the song and positions toward the right end of the overall timeline 604 correspond to times later in the song. The overall timeline 604 includes an indicator 606. The indicator 606 is located at a position along the overall timeline 604 that corresponds to a current time in the song.

The vocals interface 600 also comprises a play button 608. When the user 108 selects the play button 608, the indicator 606 progresses from left to right along the overall timeline 604. If the user 108 has already prepared an instrumental part for the song, the client 102 plays back the portions of the instrumental part occurring at the time indicated by the indicator 606 as the indicator 606 progresses along the overall timeline 604. Furthermore, if the user 108 has already prepared one or more vocal tracks for the song, the client 102 plays back the portions of the vocal tracks occurring at the time indicated by the indicator 606 as the indicator 606 progresses along the overall timeline 604. In this way, the user 108 can hear the prepared instrumental part and the prepared vocal tracks when the user 108 selects the play button 608.

The vocals interface 600 also comprises vocal track timelines 610A through 610D (collectively, “vocal track timelines 610”). Each of the vocal track timelines 610 corresponds to a different vocal track in the song. Different positions along the vocal track timelines 610 correspond to different times in the song. Positions toward the left end of the vocal track timelines 610 correspond to times early in the song and positions toward the right end of the vocal track timelines 610 correspond to times later in the song. If anything has been recorded in a vocal track, the vocal track timeline corresponding to the vocal track includes an indicator. In the example of FIG. 6, the vocal track timelines 610A and 610B include indicators 612A and 612B because data has been recorded to the vocal tracks corresponding to the vocal tracks corresponding to the vocal track timelines 610A and 610B.

The vocals interface 600 also comprises record buttons 614A through 614D (collectively, “record buttons 614”). When the user 108 selects the record button 614A, the vocals component 306 starts recording a signal from the microphone 208 as a first vocal track of the song. When the vocals component 306 is recording the signal from the microphone 208, the user 108 can sing into the microphone 208. Thus, by selecting the record button 614A and singing into the microphone 208, the user 108 can record the first vocal track of the song.

When the user 108 selects the record button 614A, the indicator 612A begins progressing along the vocal track timeline 610A and the indicator 606 begins progressing along the overall timeline 604. As the indicator 606 progresses along the overall timeline 604, the vocals component 306 causes the speaker 209 to play back the instrumental part of the song and any previously recorded vocal tracks of the song, unless the instrumental part and the previously recorded vocal tracks are muted. In this way, the user 108 can hear the instrumental part and the previously recorded vocal tracks as the user 108 is speaking or singing into the microphone 208.

The vocals interface 600 also comprises bump controls 616A through 616D (collectively, “bump controls 616”). The bump controls 616 enable the user 108 to move previously recorded vocal tracks earlier or later in the song. For example, the user 108 can record a given vocal track. Upon playing back the song, the user 108 may realize that he or she began singing the given vocal track too early or too late in the song. In this example, the user 108 can use the bump controls associated with the given vocal track to bump the given vocal track to a time earlier or later in the song. In this way, the user 108 can ensure that the given vocal track starts at the right time within the song.

The vocals interface 600 also comprises effects controls 620A through 620D (collectively, “effects controls 620”). Each of the effects controls 620 contains a title of an effect. In the example of FIG. 6, the effects controls 620A, 620C, and 620D contain the title “Reverb” and the effects control 620B contains the title “Robot.” Each of the effects controls 620 contains effect selection controls that enable the user 108 to select an effect from among a plurality of available effects. In the example of FIG. 6, the effect selection controls are shown as arrows on either side of the titles of the effects. In one example, the controls allow the user to slide through the vocal recording in certain intervals, such as 30 millisecond intervals, as each click of an arrow is made by the user.

The user 108 may be required to buy some effects before being able to apply the effects to the vocal tracks of the song. For such effects, the user 108 is allowed to try the effect before buying the effect. In the example of FIG. 6, the user 108 is required to buy the “Robot” effect. Accordingly, the effects control 620B includes controls that enable the user 108 to try or buy the “Robot” effect.

When the user 108 is allowed to apply a given effect to the vocal tracks and the user 108 has selected the given effect in a given one of the effects controls 620, the given effects control includes an on/off switch control that enables the user 108 to switch the given effect on or off for the vocal track associated with the given effects control. Furthermore, when the user 108 is allowed to apply a given effect and the user 108 has selected the given effect in a given one of the effects controls 620, the given effects control includes an intensity control. The intensity control enables the user 108 to control the intensity of the given effect.

The vocals interface 600 also includes pitch correction controls 622A through 622D (collectively, “pitch correction controls 622”). Each of the pitch correction controls 622 is associated with a different vocal track of the song. Each of the pitch correction controls 622 includes an on/off switch control. The user 108 can use the on/off switch controls in the pitch correction controls 622 to turn on or off pitch correction for the vocal tracks associated with the pitch correction controls 622. Pitch correction is a process to correct pitch in vocal performances. By applying pitch correction to a vocal track, the vocals component 306 can compensate for a lack of perfect pitch by the user 108. For this reason, pitch correction can be especially useful for novice singers.

In some embodiments, different vocal tracks of the song can be associated with different members of a band. For example, a band includes four users: Axl, Tracii, Duff, and Izzy. In this example, a first vocal track of the song can be associated with Axl, a second vocal track of the song can be associated with Tracii, a third vocal track of the song can be associated with Duff, and a fourth vocal track of the song can be associated with Izzy. In such embodiments, a user is only allowed to record sounds on a vocal track if the user is associated with that vocal track. For instance, in the previous example, Axl is allowed to record vocals on the first vocal track, but not the second, third, or fourth vocal tracks. In this way, different members of the band can collaborate on the vocal parts of the song. Furthermore, in some embodiments, a user is only allowed to add effects, add pitch correction, or bump a vocal track if the user is associated with that vocal track.

The vocals interface 600 also comprises mute buttons 618A through 618D (collectively, “mute buttons 618”). The mute buttons 618 are associated with different vocal tracks of the song. When the user 108 selects one of the mute buttons 618, the vocals component 306 mutes the vocal track associated with the selected mute button when the song is played back. In this way, the user 108 can hear what the song sounds like with and without various ones of the vocal tracks by selecting various ones of the mute buttons 618.

Reference is now made again to the example of FIG. 4. After the user 108 creates or edits the vocals part of the song, the user 108 can add samples to the song or edit the samples in the song (410). The user 108 uses a samples interface to add or edit samples in the song. In different embodiments, the samples interface can have various appearances and functionalities.

Furthermore, the user 108 can create or edit metadata for the song (412). In various embodiments, the user 108 can create or edit various types of metadata for the song. For example, the user 108 can create a title for the song. In another example, the user 108 can assign one or more genres to the song. In yet another example, the user 108 can specify one or more artists who influenced the song. In yet another example, the user 108 can specify a description of the song. In yet another example, the user 108 can specify authors and/or contributors to the song.

In various embodiments, the user 108 can use various user interfaces to create or edit the metadata for the song. For example, in the example of FIG. 5, the beatmaker interface 500 includes a title editing control 532. When the user 108 selects the title editing control 532, the beatmaker interface 500 displays an element that enables the user 108 to set the title for the song. Moreover, in the example of FIG. 5, the beatmaker interface 500 includes a genre editing control 534. When the user 108 selects the genre editing control 534, the beatmaker interface 500 displays an element that enables the user 108 to set the genre for the song. In other embodiments, the genre of the song is controlled by the song kit used to make the song. Furthermore, in the example of FIG. 6, the vocals interface 600 includes controls similar to the title editing control 532 and the genre editing control 534.

Subsequently, the user 108 releases the song (414). When the user 108 releases the song, the conversion component 310 converts the instrumental data, the vocals data, and the samples data of the song into the audio file 112. The conversion component 310 then uploads the audio file 112 to the server 104. In various embodiments, the user 108 can release the song using various user interfaces. For example, in the example of FIG. 5, the beatmaker interface 500 includes a release button 536 that, when selected, causes the song to be publicly available for download. Furthermore, in the example of FIG. 6, the vocals interface includes a release button 624 that, when selected, causes the song to be publicly available for download. When the song is released, the distribution services provided by the server 104 can add the song to one or more charts. Such charts can be accessible through a website or through social media sites, such as Facebook.

Furthermore, in some embodiments, the user interfaces of the song creation service allow the user 108 to share the song with selected people instead of releasing the song to the general public. For example, the vocals interface 600 includes a share control 626 that enables the user 108 to share the song with selected contacts on a social networking site.

In some embodiments, the user 108 can compose a song by performing actions in different sequences than the sequence illustrated in the operation 400. In order to accommodate users whose creative processes work in different ways, the order of the actions can be flexible. For example, the user 108 can create the lyrics for a song, then create the vocals for the song, then create the instrumental part of the song, and then add samples to the song. Furthermore, in some embodiments, the user 108 does not need to perform all of the actions in the operation 400. For example, the user 108 can create the vocals part of the song and then the instrumental part of the song, without creating lyrics for the song or adding samples to the song. In another example, the user 108 does not need to create an instrumental part or a vocals part of a song.

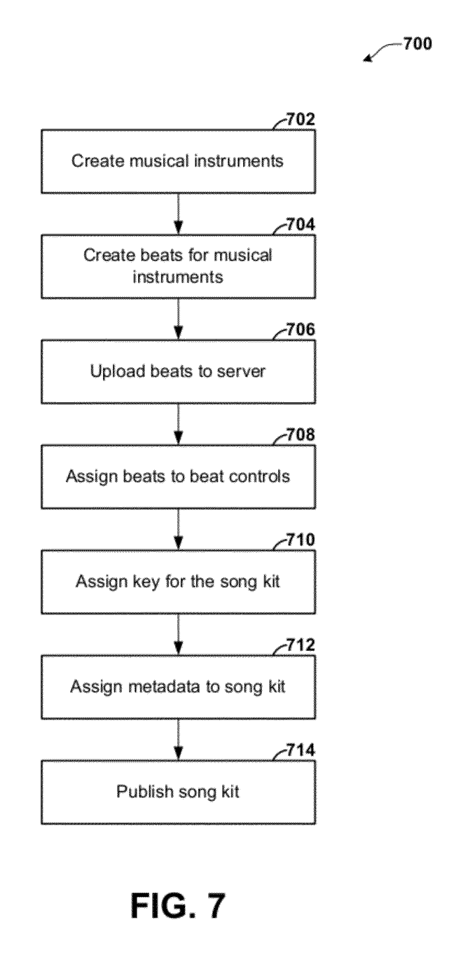

FIG. 7 is a flowchart illustrating an example operation 700 performed by a producer to generate a song kit. As illustrated in the example of FIG. 7, the operation begins when a producer creates one or more musical instruments (702). To create a musical instrument, the producer uploads audio samples to the server 104. The audio samples represent the sound waves created by the musical instrument when the musical instrument plays different notes. After uploading the audio samples, the producer assigns the samples to ranges of notes and a range of velocities. For example, the producer can assign a given sample to notes C# in a fourth octave to C# in a fifth octave. Notes within a range assigned to a sample are generated by bending the pitch represented by the sample, adjusting the velocity of the note, and/or repeating the sound waves represented by the sample.

Next, the producer creates beats for the musical instruments (704). In some embodiments, the producer does not need to create the musical instruments, but rather can rather create the beats using existing musical instruments. The producer creates a beat for a musical instrument by specifying a sequence of notes for the musical instrument.

After the producer creates the beats for the musical instruments, the producer uses a producer interface to upload the beats to the server 104 (706). The producer component 300 uses interface data received from the server to display the producer interface within a browser window. The producer interface comprises controls that enable the producer to upload the beats to the server 104.

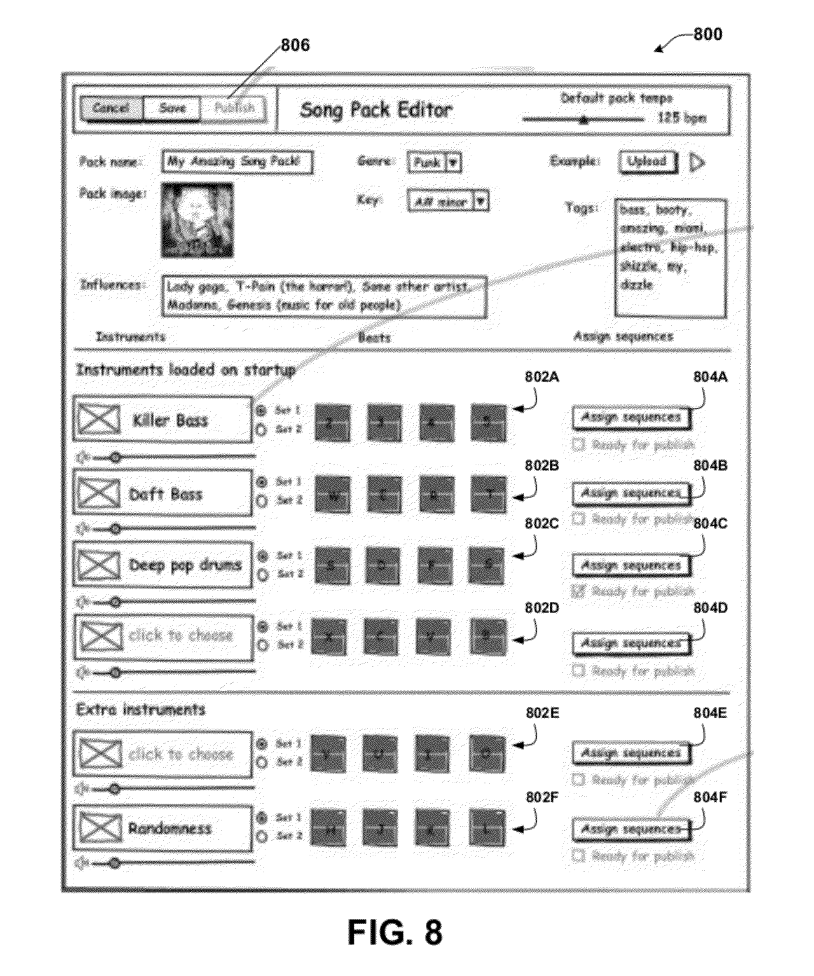

The producer then uses the producer interface to assign the beats to beat controls of a song kit (708). FIG. 8 is a screen illustration that illustrates an example producer interface 800. It should be appreciated that in other embodiments, the producer interface can have different formats, styles, controls, elements, and functionality than the producer interface 800. As illustrated in the example of FIG. 8, the producer interface 800 comprises beat controls 802A through 802F (collectively, “beat controls 802”). The beat controls 802 are analogous to the beat controls 528 in the beatmaker interface 500 illustrated in the example of FIG. 5. In addition, the producer interface 800 includes assignment controls 804A through 804F (collectively, “assignment controls 804”). Each of the assignment controls 804 is associated with one of the beat controls 802. When the producer selects the assignment control associated with one of the beat controls 802, the producer interface 800 displays one or more elements that enable the producer to assign beats to the beat controls in the beat control set.

Reference is now made again to FIG. 7. The producer assigns a key to the song kit (710). Each non-percussion beat in the song kit is in the key assigned to the song kit. For example, the song kit can include a set of bass guitar beats, a set of keyboard beats, and a set of saxophone beats. In this example, each of these beats can be in the key of C#. Having all of the non-percussion beats in the song kit in the same key can help to ensure harmonic cohesion of songs created using the song kit.

The producer assigns metadata to the song kit (712). In various embodiments, the producer can assign various types of metadata to the song kit. For example, the producer can assign a title, a genre, one or more tags, one or more artist influences, and other types of metadata to the song kit. In this example, the producer can, for instance, assign a genre of “80s Metal” to the song kit, assign the tags “hair” and “glam” to the song kit, and assign the bands “Van Halen,” “Whitesnake,” and “Twister Sister” as artist influences to the song kit. Such song kit metadata can help users identify song kits that would help them create the desired types of songs. This is because the users would know that each of the beats in the song kit would be consistent with genre, tags, and artist influences assigned to the song kit.

After the producer assigns the metadata to the song kit, the producer publishes the song kit (714). By publishing the song kit, the producer makes the song kit available for use by people to compose songs using the song kit. In the example of FIG. 8, the producer interface 800 includes a publish control 806. When the publish control 806 is selected, the song kit is published. In some instances, the producer may charge a fee for use of the song kit.

In addition to producing song kits, the producer can also create new effects that users can apply to instrumental or vocal parts of songs. In some embodiments, the producer can create a new effect by modifying one or more parameters of an existing effect provided by the song creation service. For example, the song creation service can provide default delay, filter, distortion, degrader, modulation, and/or reverb effects. For instance, in this example, the producer can create a new effect by modifying a dry/wet parameter of the delay effect, a delay-in-beats parameter of the delay effect, a delay-in-seconds parameter and/or a feedback parameter of the delay effect. The producer can also assign names to the new effects. For example, the producer can name a new effect “wet delay.”

In another example, the producer can create separate beat kits and vocal kits as part of a kit package.

In beat kit production, the producer creates audio samples and/or MIDI files. These audio samples will ultimately be uploaded to the system using the producer interface. Next, the producer assigns metadata, a tempo, and musical key to the beat kit. After the producer creates the samples and inputs information for the kit, the producer uses a producer interface to select an instrument type, to which the samples will be assigned. Then the producer uploads the corresponding samples to the server using the producer interface. In alternative embodiments, the producer can also upload other types of files, such as audio loops.

When all required pieces of the beat kit are uploaded and completed, the producer submits the kit to the system for approval from a supervisor, then the kit is published. By publishing the beat kit, the producer makes the beat kit available for use by people to compose songs using the beat kit. In some instances, the producer may charge a fee for use of the beat kit.

In vocal kit production, the producer creates a full-length song recording. These song files will ultimately be uploaded to the system using the producer interface. Next, the producer assigns metadata, a tempo, and musical key to the beat kit using the information form presented in the interface. Then the producer uploads the song files to the system using the producer interface. The song files are separated into their individual parts before uploading—(a) Instrumental only, (b) Vocals only, (c) Full song mixdown.

After the producer has filled out the information form for the kit and has uploaded the proper audio files, the producer enters the lyrics tool producer interface. In this interface, the producer is presented with a visual linear display of the song. Using the producer interface, the producer breaks the song into song sections by clicking and dragging on the timeline. The alignment of each section is snapped to the nearest measure. Next, the producer is presented with a zoomed in view of the song (now broken into sections). Using the producer interface, the producer draws lyric regions within each song section. The alignment of each lyric region is snapped to the nearest beat. Also, the producer inputs the lyrics for each lyric region by typing text into the corresponding field in the producer interface. Next, the producer reviews the lyrics and timing as the song is played back. Finally, the completed kit is submitted to the supervisor for approval and publication.

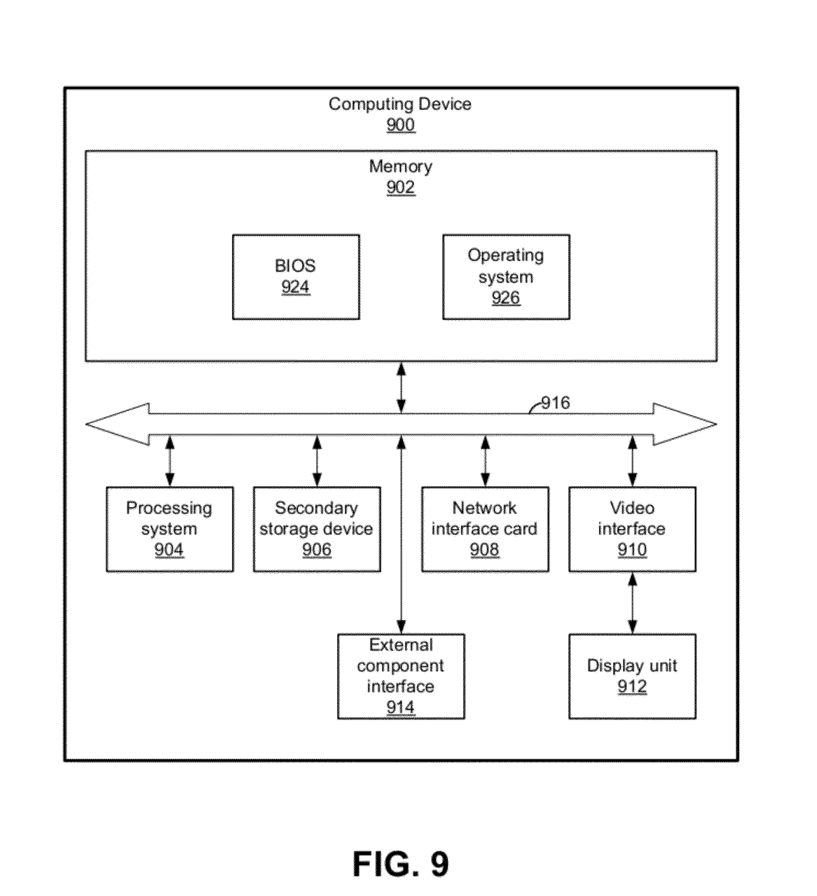

FIG. 9 is a block diagram illustrating an example computing device 900. In some embodiments, the client 102 and/or the server 104 are implemented using one or more computing devices like the computing device 900. It should be appreciated that in other embodiments, the client 102 and/or the server 104 are implemented using computing devices having hardware components other than those illustrated in the example of FIG. 9.

In different embodiments, computing devices are implemented in different ways. For instance, in the example of FIG. 9, the computing device 900 comprises a memory 902, a processing system 904, a secondary storage device 906, a network interface card 908, a video interface 910, a display unit 912, an external component interface 914, and a communication medium 916. In other embodiments, computing devices are implemented using more or fewer hardware components. For instance, in another example embodiment, a computing device does not include a video interface, a display unit, an external storage device, or an input device.

The term computer readable media as used herein may include computer storage media. Computer storage media may include volatile and nonvolatile, removable and non-removable media implemented in any method or technology for storage of information, such as computer readable instructions, data structures, program modules, or other data. The memory 902 includes one or more computer storage media capable of storing data and/or instructions. As used in this document, a computer storage medium is a device or article of manufacture that stores data and/or software instructions readable by a computing device. In different embodiments, the memory 902 is implemented in different ways. For instance, in various embodiments, the memory 902 is implemented using various types of computer storage media. Example types of computer storage media include, but are not limited to, dynamic random access memory (DRAM), double data rate synchronous dynamic random access memory (DDR SDRAM), reduced latency DRAM, DDR2 SDRAM, DDR3 SDRAM, Rambus RAM, solid state memory, flash memory, read-only memory (ROM), electrically-erasable programmable ROM, and other types of devices and/or articles of manufacture that store data.

The term computer readable media as used herein may also include communication media. Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media.

The processing system 904 includes one or more physical integrated circuits that selectively execute software instructions. In various embodiments, the processing system 904 is implemented in various ways. For example, the processing system 904 can be implemented as one or more processing cores. In this example, the processing system 904 can comprise one or more Intel Core 2 microprocessors. In another example, the processing system 904 can comprise one or more separate microprocessors. In yet another example embodiment, the processing system 904 can comprise an ASIC that provides specific functionality. In yet another example, the processing system 904 provides specific functionality by using an ASIC and by executing software instructions. In another example, the processing system 904 is an ARM7 processor. In different embodiments, the processing system 904 executes software instructions in different instruction sets. For example, the processing system 904 executes software instructions in instruction sets such as the x86 instruction set, the POWER instruction set, a RISC instruction set, the SPARC instruction set, the IA-64 instruction set, the MIPS instruction set, and/or other instruction sets.

The secondary storage device 906 includes one or more computer storage media. The secondary storage device 906 stores data and software instructions not directly accessible by the processing system 904. In other words, the processing system 904 performs an I/O operation to retrieve data and/or software instructions from the secondary storage device 906. In various embodiments, the secondary storage device 906 is implemented by various types of computer-readable data storage media. For instance, the secondary storage device 906 may be implemented by one or more magnetic disks, magnetic tape drives, CD-ROM discs, DVD-ROM discs, Blu-Ray discs, solid state memory devices, Bernoulli cartridges, and/or other types of computer-readable data storage media.

The network interface card 908 enables the computing device 900 to send data to and receive data from a communication network. In different embodiments, the network interface card 908 is implemented in different ways. For example, in various embodiments, the network interface card 908 is implemented as an Ethernet interface, a token-ring network interface, a fiber optic network interface, a wireless network interface (e.g., WiFi, WiMax, etc.), or another type of network interface.

The video interface 910 enables the computing device 900 to output video information to the display unit 912. In different embodiments, the video interface 910 is implemented in different ways. For instance, in one example embodiment, the video interface 910 is integrated into a motherboard of the computing device 900. In another example embodiment, the video interface 910 is a video expansion card. In various embodiments, the display unit 912 can be a cathode-ray tube display, an LCD display panel, a plasma screen display panel, a touch-sensitive display panel, an LED screen, a projector, or another type of display unit. In various embodiments, the video interface 910 communicates with the display unit 912 in various ways. For example, the video interface 910 can communicate with the display unit 912 via a Universal Serial Bus (USB) connector, a VGA connector, a digital visual interface (DVI) connector, an S-Video connector, a High-Definition Multimedia Interface (HDMI) interface, a DisplayPort connector, or another type of connection.

The external component interface 914 enables the computing device 900 to communicate with external devices. In various embodiments, the external component interface 914 is implemented in different ways. For example, the external component interface 914 can be a USB interface, a FireWire interface, a serial port interface, a parallel port interface, a PS/2 interface, and/or another type of interface that enables the computing device 900 to communicate with external devices. In different embodiments, the external component interface 914 enables the computing device 900 to communicate with different external components. For example, the external component interface 914 can enable the computing device 900 to communicate with external storage devices, input devices, speakers, phone charging jacks, modems, media player docks, other computing devices, scanners, digital cameras, a fingerprint reader, and other devices that can be connected to the computing device 900. Example types of external storage devices include, but are not limited to, magnetic tape drives, flash memory modules, magnetic disk drives, optical disc drives, flash memory units, zip disk drives, optical jukeboxes, and other types of devices comprising one or more computer storage media. Example types of input devices include, but are not limited to, keyboards, mice, trackballs, stylus input devices, key pads, microphones, joysticks, touch-sensitive display screens, and other types of devices that provide user input to the computing device 900.

The communications medium 916 facilitates communication among the hardware components of the computing device 900. In different embodiments, the communications medium 916 facilitates communication among different components of the computing device 900. For instance, in the example of FIG. 9, the communications medium 916 facilitates communication among the memory 902, the processing system 904, the secondary storage device 906, the network interface card 908, the video interface 910, and the external component interface 914. In different implementations of the computing device 900, the communications medium 916 is implemented in different ways. For instance, in different implementations of the computing device 900, the communications medium 916 may be implemented as a PCI bus, a PCI Express bus, an accelerated graphics port (AGP) bus, an Infiniband interconnect, a serial Advanced Technology Attachment (ATA) interconnect, a parallel ATA interconnect, a Fiber Channel interconnect, a USB bus, a Small Computing system Interface (SCSI) interface, or another type of communications medium.

The memory 902 stores various types of data and/or software instructions. For instance, in the example of FIG. 9, the memory 902 stores a Basic Input/Output System (BIOS) 924, and an operating system 926. The BIOS 924 includes a set of software instructions that, when executed by the processing system 904, cause the computing device 900 to boot up. The operating system 926 includes a set of software instructions that, when executed by the processing system 904, cause the computing device 900 to provide an operating system that coordinates the activities and sharing of resources of the computing device 900.

The various embodiments described above are provided by way of illustration only and should not be construed as limiting. Those skilled in the art will readily recognize various modifications and changes that may be made without following the example embodiments and applications illustrated and described herein. For example, the operations shown in the figures are merely examples. In various embodiments, similar operations can include more or fewer steps than those shown in the figures. Furthermore, in other embodiments, similar operations can include the steps of the operations shown in the figures in different orders.

What is claimed is:

1. A method for creating a song, the method comprising:
receiving, by a client, interface data from a server;
using, by the client, the interface data to display one or more user interfaces within one or more browser windows, the one or more browser windows being windows associated with a web browser application;
generating, by the client, instrumental data in response to input received by the client from a user via the one or more user interfaces, the instrumental data representing an instrumental part of the song;
generating, by the client, vocals data in response to input received by the client via the one or more user interfaces, the vocals data representing a vocals part of the song, the vocals data generated using a signal from a microphone, the microphone controlled by the user via the one or more user interfaces; and
generating, by the client, an audio file using the instrumental data and the vocals data, the audio file comprising a digital recording of the song.

2. The method of claim 1, further comprising sending, by the client, one or more requests to the server via a communications network, the one or more requests being for the interface data, the client sending the one or more requests in response to input received by the client via the web browser application.

3. The method of claim 1, further comprising: sending, by the client, the audio file to the server.

4. The method of claim 1, wherein using the interface data to display the one or more user interfaces comprises: displaying, by the client, a beatmaker interface within the one or more browser windows, the beatmaker interface comprising beat controls, the beat controls enabling the user to compose a part of the song for a musical instrument by starting and stopping looping of one or more pre-defined beats associated with the musical instrument.

5. The method of claim 4,
wherein each of the beat controls is assigned to a different key on a QWERTY keyboard; and
wherein generating the instrumental data comprises: recording a time to start or stop looping a given beat in response to the user pressing the key of the QWERTY keyboard assigned to a given beat control, the given beat being one of the pre-defined beats, the given beat control being one of the beat controls, the given beat control associated with the given beat.

6. The method of claim 4, wherein the method further comprises: applying an effect to the part of the song associated with the musical instrument in response to input received by the client from the user via the beatmaker interface.

7. The method of claim 4,
wherein the method further comprises: receiving, by the client, song kit selection input from the user via the one or more user interfaces, the song kit selection input indicating a selected song kit selected by the user from among a plurality of available song kits, each of the available song kits comprising a set of beats for musical instruments;
wherein displaying the beatmaker interface comprises: displaying, by the client, beat controls associated with pre-defined beats for the musical instruments associated with the selected song kit;
wherein generating the instrumental data comprises: generating data that specifies a sequence of notes in a given beat, the sequence of notes starting and stopping when the user selects or un-selects one of the beat controls associated with the given beat.

8. The method of claim 1,
wherein using the interface data to display the one or more user interfaces comprises: using, by the client, the interface data to display a samples interface; and
wherein the method further comprises: adding a sample to the song in response to input received by the client from the user via the samples interface.

9. The method of claim 1,
wherein using the interface data to display the one or more user interfaces comprises: using, by the client, the interface data to display a vocals interface; and
wherein the method further comprises: recording the signal from the microphone as a vocal track in the song in response to input received by the client from the user via the vocals interface.

10. The method of claim 9, wherein the method further comprises: applying an effect to the vocal track in response to input received by the client from the user via the vocals interface.

11. A method comprising:
sending, by a server, interface data to a composer client, the interface data causing the composer client to:
display one or more user interfaces within one or more browser windows, the one or more browser windows being windows associated with a web browser application;
generate instrumental data in response to input received by the composer client from a user via the one or more user interfaces, the instrumental data representing an instrumental part of a song;
generate vocals data in response to input received by the composer client via the one or more user interfaces, the vocals data representing a vocals part of the song, the vocals data generated using a signal from a microphone, the microphone controlled by the user via the one or more user interfaces, and
generate an audio file using the instrumental data and the vocals data, the audio file comprising an audio recording of the song; and
receiving, by the server, the audio file from the composer client.

12. The method of claim 11, further comprising:
sending, by the server, producer interface data to a producer client, the producer interface data causing the producer client to:
display a producer interface; and
generate song kit data in response to input received by the producer client from a producer via the producer interface, the song kit data specifying a set of beats associated with a musical instrument; and
receiving, by the server, the song kit data from the producer client.

13. The method of claim 12,
wherein the interface data causes the composer client to display a beatmaker interface within the one or more browser windows, the beatmaker interface comprising beat controls, each of the beat controls associated with a different one of the beats associated with the musical instrument; and
wherein the interface data causes the composer client to generate the instrumental data by causing the composer client to: record data representing a sequence of notes in a given beat, the sequence of notes starting and stopping in response to selection by the user of one of the beat controls associated with the given beat.

14. The method of claim 11,
wherein the interface data causes the composer client to display a vocals interface within the one or more browser windows; and
wherein the interface data causes the composer client to record the signal from the microphone as a vocal track in response to input received by the composer client from the user via the vocals interface.

15. A computing device comprising:
a processing unit; and
one or more computer storage media storing computer-executable instructions that, when executed by the processing unit, cause the computing device to:
receive interface data from a server;
use the interface data to display one or more user interfaces within one or more browser windows, the one or more browser windows being windows associated with a web browser application;
generate instrumental data in response to input received by the client from a user via the one or more user interfaces, the instrumental data representing an instrumental part of a song;
generate vocals data in response to input received by the client via the one or more user interfaces, the vocals data representing a vocals part of the song, the vocals data generated using a signal from a microphone, the microphone controlled by the user via the one or more user interfaces; and
generate an audio file using the instrumental data and the vocals data, the audio file comprising a digital recording of the song.

16. The computing device of claim 15, wherein the computer-executable instructions, when executed by the processing unit, further cause the computing device to:
display a beatmaker interface within one of the one or more browser windows, the beatmaker interface comprising beat controls; and
start or stop playing a beat in response to selection by the user of a given one of the beat controls.

17. The computing device of claim 15, wherein the computer-executable instructions, when executed by the processing unit, further cause the computing device to:
display a vocals interface within one of the one or more browser windows; and
record the signal from the microphone as a vocal track of the song in response to input received by the computing device from the user via the vocals interface.

18. A computing device comprising:
a processing unit; and
one or more computer storage media storing computer-executable instructions that, when executed, cause the computing device to:
send interface data to a composer client, the interface data causing the composer client to:
display one or more user interfaces within one or more browser windows, the one or more browser windows being windows associated with a web browser application,
generate instrumental data in response to input received from a user via the one or more user interfaces, the instrumental data representing an instrumental part of a song,
generate vocals data in response to input received from the user via the one or more user interfaces, the vocals data representing a vocals part of the song, the vocals data generated using a signal from a microphone, the microphone controlled by the user via the one or more user interfaces, and
generate an audio file using the instrumental data and the vocals data, the audio file comprising a digital recording of the song; and
receive the audio file from the composer client.

19. A computer storage medium storing computer-executable instructions that, when executed by a computing device, cause the computing device to:
receive interface data from a server;
use the interface data to display one or more user interfaces within one or more browser windows, the one or more browser windows being windows associated with a web browser application;
generate instrumental data in response to input received from a user via the one or more user interfaces, the instrumental data representing an instrumental part of a song;
generate vocals data in response to input received from the user via the one or more user interfaces, the vocals data representing a vocals part of the song, the vocals data generated using a signal from a microphone, the microphone controlled by the user via the one or more user interfaces; and
generate an audio file using the instrumental data and the vocals data, the audio file comprising a digital recording of the song.

20. A computer storage medium storing computer-executable instructions that, when executed by a computing device, cause the computing device to:
send interface data to a composer client, the interface data causing the composer client to:
display one or more user interfaces within one or more browser windows, the one or more browser windows being windows associated with a web browser application,
generate instrumental data in response to input received from a user via the one or more user interfaces, the instrumental data representing an instrumental part of a song,
generate vocals data in response to input received from the user via the one or more user interfaces, the vocals data representing a vocals part of the song, the vocals data generated using a signal from a microphone, the microphone controlled by the user via the one or more user interfaces, and
generate an audio file using the instrumental data and the vocals data, the audio file comprising a digital recording of the song; and
receive the audio file from the composer client.
